(19) United States
(12) Patent Application Publication
(10) Pub. No.: US 2021/0015137 A1
(43) Pub. Date: Jan. 21, 2021

(54) Edible Granules with Varied Flavors and Their Preparation Methods

(71) Applicant: Panasia (Wuhan) Food Science Co., Ltd., Ezhou (CN)

(72) Inventors: Zhen CHEN, Wuhan (CN); Guotai LEI, Wuhan (CN); Junfeng DING, Jingmen (CN)

(21) Appl. No.: 16/540,920

(22) Filed: Aug. 14, 2019

(30) Foreign Application Priority Data
Jul. 15, 2019 (CN) 201910634733.3

(51) Int. Cl. A23L 27/00; A23L 27/40; A23L 27/30; A23L 27/26; A23L 27/29; A23G 3/34; A21D 13/30; A23G 1/30

(52) U.S. Cl. CPC A23L 27/88; A23L 27/40; A23L 27/33; A23L 27/26; A23V 2002/00; A23G 3/343; A21D 13/30; A23G 1/305; A23L 27/29

(57) ABSTRACT

The present invention discloses edible granules with varied flavors, relating to the technical field of food. The present invention comprises carbohydrates, water, emulsifiers, salt, sweeteners, flavor enhancers, acidity modifiers, food flavors, food colors and antioxidants, wherein the amounts of them are: carbohydrates 70-80%, water 10-20%, emulsifiers 0-10%, salt 0-10%, sweeteners 0-10%, flavor enhancers 0-2%, acidity modifiers 0-2%, food flavors 0.01-1%, food colors 0-0.5% and antioxidants 0.01-0.04%. In the present invention, through different components of carbohydrates, water, emulsifiers, salt, sweeteners, flavor enhancers, acidity modifiers, food flavors, food colors and antioxidants, edible granules with varied flavors may be prepared without adding natural substances in the granules of the present invention, so that the problem that the existing natural seasonings have a single taste and are difficult to prepare is solved.

### FIELD OF THE INVENTION

The present invention relates to a novel type of edible granules with varied flavors and their preparation methods.

### BACKGROUND OF THE INVENTION

With the continuous improvement of people's living standards, more and more consumers are requesting that foods be a perfect combination of color, aroma, and taste. Many food ingredients are developed and commercialized to make the appearance of food stuff more appealing. For example, sugar pearls and sprinkles are applied mainly for decoration of bakery products such as cake, biscuit and donut, and confectionary products. Applying sugar pearls and sprinkles to the top of cake and candy will make the products more attractive to the consumers. Sugar pearls are made of sugar, starch, food colors, emulsifiers, and glazing agents. Though they are beautifully colorful, they can only provide one single taste which is sweet.

Common seasonings (condiments) such as pepper, chili, curry, ginger and garlic are widely used in food industry. They have varied tastes and flavors, but the number of seasonings are limited. Besides, nowadays, these seasonings have their own problems such as price fluctuation, pesticide residue, and molding during storage etc.

There is an ongoing need in the food industry to develop new food ingredients so the manufacturers could create foods with a perfect combination of color, aroma, and taste.

At the same time, for natural seasonings such as cumin and pepper, the yield and price of such natural seasonings will fluctuate. During production and manufacturing, it is necessary to solve the problem of pesticide residues. Meanwhile, the sterilization requirements are high when in use, the preparation method is complicated, and the production efficiency is insufficient.

Therefore, designing edible granules with varied flavors that are easy to produce and easy to manufacture is a problem to be solved by those skilled in the art.

### SUMMARY OF THE INVENTION

The present invention provides a novel type of edible granules, the granules described herein are both decorative (colorful) and functional (tasteful) with varied flavors. The granules are made of following ingredients: carbohydrates, water, emulsifiers, salt, sweeteners, flavor enhancers, acidity modifiers, food flavors, food colors and antioxidants, without adding natural substances, so that the problem that the existing natural seasonings have a single taste and are difficult to prepare is solved.

### DETAILED DESCRIPTION OF THE INVENTION

The edible granules contains: carbohydrates, water, emulsifiers, salt, sweeteners, flavor enhancers, acidity modifiers, food flavors, food colors and antioxidants.

In addition, the edible granules described herein have the ingredient ratio (w/w) of: carbohydrates 70-80%, water 10-20%, emulsifiers 0-10%, salt 0-10%, sweeteners 0-10%, flavor enhancers 0-2%, acidity modifiers 0-2%, food flavors 0.01-1%, food colors 0-0.5% and antioxidants 0.01-0.04%.

In addition, the carbohydrates described herein are sugar, glucose, starch, fructose, trehalose, food fiber, and dextrin etc. They can be used individually or used as a combination of two or more of them.

In addition, the emulsifiers described herein are Arab gum, guar gum, pectins, propylene glycol esters of fatty acids, mono- and diglycerides of fatty acids, propylene glycol alginate, succinylated monoglycerides, polyglycerol polyricinoleate, polyglycerol esters of fatty acids, polyoxyethylenexylitanmonostearate (Tween 20, 40, 60, 80), carrageenan, soybean polysaccharide, citric and fatty acid esters of glycerol, glycerol ester of hydrogenated rosin, sorbitan fatty acid esters (Span 20, 40, 60, 65, 80), diacetyl tartaric acid ester of mono glycerides, octyl and decylglycerate, sodium starch octenyl succinate, potassium stearate, and sucrose esters of fatty acid etc. They can be used individually or used as a combination of two or more of them.

In addition, the salt described herein are sodium chloride and potassium chloride. They can be used individually or used as a combination of two or more of them.

In addition, the flavor enhancers described herein are alanine, glycine, disodium succinate, paprika oleoresin, monosodium glutamate, disodium inosine 5′-monophospate, and disodium guanosine 5′-monophosphate etc. They can be used individually or used as a combination of two or more of them.

In addition, the sweeteners described herein are neotame, glycyrrhizinate salts, mannitol, cyclamate salts, maltitol, lactitol, sucralose, sorbitol, thaumatin, sodium saccharin, alitame, aspartame, steviol glycosides, acesulfame potassium, isomaltulose, and mogroside V etc. They can be used individually or used as a combination of two or more of them.

In addition, the acidity modifiers described herein arefumaric acid (and its salt), adipic acid, tartaric acid, phosphoric acid (and its salts), calcium sulfate, citric acid (and its salt), metatartaric acid, potassium hydroxide, calcium hydroxide, lactic acid, potassium carbonate, sodium carbonate, and hydrochloric acid etc. They can be used individually or used as a combination of two or more of them.

In addition, the food flavors described herein include both natural flavors such as essential oils and synthetic flavors. Generally flavors can be categorized according to their taste characteristics, such as fruit flavors, flower flavors, meat flavors, seafood flavors, green flavors, cooling flavors, wood flavors, seasoning flavors, liquor flavors, dairy flavors, nut flavors, preserved fruit flavors. They can be used individually or used as a combination of two or more of them.

In addition, the food colors described herein are erythrosine, indigotine, titanium dioxide, lycopene, orange yellow, riboflavin, black currant red, carthamins yellow, monascus yellow pigment, monascus red, beta carotene, turmeric, curcumin, caramel color, quinolone yellow, paprika red, brilliant blue, tartrazine, sunset yellow, amaranth, carmine cochineal, copper chlorophyll, lutein, allura red, corn yellow, gardenia blue, gardenia yellow, and carbon blacketc. They can be used individually or used as a combination of two or more of them.

In addition, the antioxidants described herein are tea polyphenol, tea polyphenol palmitate, butylated hydroxyanisole, butylated hydroxytoluene, sulfur dioxide, potassium metabisulphite, sodium metabisulphite, glycyrrhiza extract, 4-hexylresorcinol, ascorbic acid (and its salts), ascorbyl palmitate, phospholipid, dilaurylthiodipropionate, propyl gallate, rosemary extract, sorbic acid, tertiary butylhydroquinone, vitamin E, disodium ethylene-diamine-tetra-acetate, isoascorbic acid, phytic acid, and bamboo extract etc. They can be used individually or used as a combination of two or more of them.

In addition, the edible granules described herein are prepared as follows:

Step 1: weigh carbohydrates, salt, sweeteners, and acidity modifiers according to the predetermined ratio; mix them well and grind into powders.

Step 2: weigh water, emulsifiers, food flavors and food colors according to the predetermined ratio; mix them well to make a homogeneous solution.

Step 3: put the powders on the spouted fluidized bed, keep the temperature of bed between 60-90° C.; spray the solution onto the bed, while the temperature of spray nozzle is kept at 60-100° C. The granules form gradually, and they are ball-shaped with diameters between 0.5-10 mm.

The edible granules described herein have the following advantages:
1. they are made of carbohydrates, water, emulsifiers, salt, sweeteners, flavor enhancers, acidity modifiers, food flavors, food colors and antioxidants. And the granules described herein may be configured to have a wide range of flavor properties, such as strawberry flavor granule, cumin flavor granule, pepper flavor granule and milk flavor etc. The granules can not only decorate foods, but also bring a multiple-layer, rich taste experience. At the same time, they can be used in but not limited to confectionary products, chocolate products, bakery products, snack foods, meat products and dairy products etc.
2. The edible granules of the present invention do not need to be added with natural substances during production. Compared with the production of existing natural seasonings, the price or yield of natural products is not required to be considered, and there is no need to solve the problem of pesticide residues, so that the sterilization requirements during use may be reduced, which facilitates the production and preparation by the user, greatly improving the production efficiency of the seasoning

### EXAMPLE

The following are provided as specific embodiments of the present invention. Other modifications of this invention will be readily apparent to those skilled in the art. Such modifications are understood to be within the scope of this invention.

### Example 1

### Preparation of Strawberry Flavor Edible Granule

The strawberry flavor edible granule is made of the following ingredients (Table 1): sugar, dextrin, sodium chloride, citric acid, water, syrup, strawberry flavor, and allura red.

TABLE 1
Strawberry flavor granule

| Ingredients | Amount (gram) |
|---|---|
| Sugar | 786.84 |
| Syrup | 56 |
| Dextrin | 23 |
| Sodium chloride | 10 |
| Citric acid | 10 |
| Strawberry flavor* | 4 |
| Allura red | 0.16 |
| Water | 110 |
| Total | 1000 |

*Purchased from International Flavors & Fragrances Inc. New York, NY, USA

Weigh sugar, dextrin, sodium chloride, and citric acid, mix them well and grind the mixture into powder. Put the powder on the spouted fluidized bed, keep the temperature of bed between 60-90° C.; Weigh water, syrup, strawberry flavor, and allura color, mix them well into a homogenous solution. Spray the solution onto the fluidized bed, while the temperature of spray nozzle is kept at 60-100° C. The strawberry flavor granule form in 0.5 hour, they are ball-shaped with diameters between 1-3 mm.

### Example 2

### Preparation of Apple Flavor Edible Granule

The apple flavor edible granule is made of the following ingredients (Table 2): sugar, dextrin, sodium chloride, citric acid, water, syrup, apple flavor, brillant blue, and orange yellow.

TABLE 2
Apple flavor granule

| Ingredients | Amount (gram) |
|---|---|
| Sugar | 800 |
| Syrup | 46 |
| Dextrin | 22.9 |
| Sodium chloride | 10 |
| Citric acid | 10 |
| Apple flavor* | 1 |
| Brilliant blue | 0.3 |
| Citric yellow | 0.1 |
| Water | 109.7 |
| Total | 1000 |

*Purchased from International Flavors & Fragrances Inc. New York, NY, USA

Weigh sugar, dextrin, sodium chloride, and citric acid, mix them well and grind the mixture into powder. Put the powder on the spouted fluidized bed, keep the temperature of bed between 60-90° C.; Weigh water, syrup, apple flavor, brilliant blue, and citric yellow, mix them well into a homogenous solution. Spray the solution onto the fluidized bed, while the temperature of spray nozzle is kept at 60-100° C. The apple flavor granule form in 0.5 hour, they are ball-shaped with diameters between 1-3 mm.

### Example 3

### Preparation of Pepper Flavor Edible Granule

The pepper flavor edible granule is made of the following ingredients (Table 3): starch, monosodium glutamate, sodium chloride, water, dextrin, sucrose esters of fatty acid, pepper flavor, brillant blue, and sun set yellow color.

TABLE 3
Pepper flavor granule

| Ingredients | Amount (gram) |
|---|---|
| Starch | 800 |
| Monosodium | 10 |
| glutamate | |
| Dextrin | 20 |
| Sodium chloride | 10 |
| Sucrose esters | 10 |
| of fatty acid | |
| Pepper flavor* | 3 |
| Brilliant blue | 0.1 |
| Sun set yellow | 0.4 |
| Water | 146.5 |
| Total | 1000 |

*Purchased from International Flavors & Fragrances Inc. New York, NY, USA

Weigh starch, monosodium glutamate, and sodium chloride, mix them well and grind the mixture into powder. Put the powder on the spouted fluidized bed, keep the temperature of bed between 60-90° C.; Weigh water, dextrin, sucrose esters of fatty acid, pepper flavor, brilliant blue, and sun set yellow, mix them well into a homogenous solution. Spray the solution onto the fluidized bed, while the temperature of spray nozzle is kept at 60-100° C. The pepper flavor granule form in 0.5 hour, they are ball-shaped with diameters between 1-3 mm.

### Example 4

### Preparation of Mint Flavor Edible Granule

The mint flavor edible granule is made of the following ingredients (Table 4): sugar, sodium chloride, water, dextrin, sucrose esters of fatty acid, mint flavor, and brillant blue color.

TABLE 4
Mint flavor granule

| Ingredients | Amount (gram) |
|---|---|
| Sugar | 800 |
| Dextrin | 20 |
| Sodium chloride | 10 |
| Sucrose esters | 10 |
| of fatty acid | |
| Mint flavor* | 3 |
| Brilliant blue | 0.4 |
| Water | 156.6 |
| Total | 1000 |

*Purchased from International Flavors & Fragrances Inc. New York, NY, USA

Weigh sugar and sodium chloride, mix them well and grind the mixture into powder. Put the powder on the spouted fluidized bed, keep the temperature of bed between 60-90° C.; Weigh water, dextrin, sucrose esters of fatty acid, mint flavor, and brilliant blue, mix them well into a homogenous solution. Spray the solution onto the fluidized bed, while the temperature of spray nozzle is kept at 60-100° C. The mint flavor granule form in 0.6 hour, they are ball-shaped with diameters between 1-3 mm.

### Example 5

### Preparation of Milk Flavor Edible Granule

The milk flavor edible granule is made of the following ingredients (Table 5): sugar, sodium chloride, monosodium glutamate, water, dextrin, sucrose esters of fatty acid, milk flavor, and brillant blue color.

TABLE 5
Milk flavor granule

| Ingredients | Amount (gram) |
|---|---|
| Sugar | 800 |
| Dextrin | 20 |
| Sodium chloride | 10 |
| Sucrose esters | 10 |
| of fatty acid | |
| Monosodium | 20 |
| glutamate | |
| Milk flavor* | 3 |
| Disodium | 5 |
| succinate | |
| Water | 132 |
| Total | 1000 |

*Purchased from International Flavors & Fragrances Inc. New York, NY, USA

Weigh sugar sodium chloride, monosodium glutamate, and disodium succinate, mix them well and grind the mixture into powder. Put the powder on the spouted fluidized bed, keep the temperature of bed between 60-90° C.; Weigh water, dextrin, sucrose esters of fatty acid, and milk flavor, mix them well into a homogenous solution. Spray the solution onto the fluidized bed, while the temperature of spray nozzle is kept at 60-100° C. The milk flavor granule form in 0.4 hour, they are ball-shaped with diameters between 1-3 mm.

### Example 6

### Preparation of Beaf Flavor Edible Granule

The beaf flavor edible granule is made of the following ingredients (Table 6): starch, sodium chloride, monosodium glutamate, disodium inosine 5′-monophospate, disodium guanosine 5′-monophosphate, water, dextrin, sucrose esters of fatty acid, beaf flavor, and caramel color.

TABLE 6
Beaf flavor granule

| Ingredients | Amount (gram) |
|---|---|
| Starch | 800 |
| Dextrin | 20 |
| Sodium chloride | 10 |
| Monosodium | 15 |
| glutamate | |
| Sucrose esters of | 10 |
| fatty acid | |
| Disodium inosine | 0.4 |
| 5’-monophospate | |
| Disodium guanosine | 0.4 |
| 5’-monophosphate | |
| Beef flavor* | 3 |
| Caramel color | 4 |
| Water | 127.2 |
| Total | 1000 |

*Purchased from International Flavors & Fragrances Inc. New York, NY, USA

Weigh starch, sodium chloride, monosodium glutamate, disodium inosine 5′-monophospate, and disodium guanosine 5′-monophosphate, mix them well and grind the mixture into powder. Put the powder on the spouted fluidized bed, keep the temperature of bed between 60-90° C.; Weigh water, dextrin, sucrose esters of fatty acid, beef flavor, and caramel color, mix them well into a homogenous solution. Spray the solution onto the fluidized bed, while the temperature of spray nozzle is kept at 60-100° C. The beef flavor granule form in 0.4 hour, they are ball-shaped with diameters between 1-3 mm.

### Example 7

### Applications of the Edible Granule Described in the Present Invention

1. Add 5-50% (weight) of granules described in the present invention to freshly made popcorn. While the popcorn is hot, the granules will stay on its oily surface. Shake and cool down to room temperature. The food processers will choose the flavor of granules applied depends on consumer preferences, single flavor granule can be used or a combination of two types or more can be used. The popcorns thus made have attractive appearance. The granules also bring extra flavor to the popcorns besides the original taste.
2. Prepare the syrup for making lollipop as usual. During cooling, when the syrup reaches 90° C., add 5-20% (weight) of granules described in the present invention, mix well. The food processers will choose the flavor of granules applied depends on consumer preferences, single flavor granule can be used or a combination of two types or more can be used. Stir well and pour the syrup into mold while it is still hot. Cool down to room temperature, the lollipop thus made contain colorful granules inside, which is visually appealing. In addition, the granules inside also bring extra flavor to the lollipop besides its basic taste.
3. Add 5-40% (weight) of granules described in the present invention to pastry fillings, mix well. The food processers will choose the flavor of granules applied depends on consumer preferences, single flavor granule can be used or a combination of two types or more can be used. When consumers eat the pastry containing the filling thus made, they can notice the colorful granules and also taste the extra flavors the granules bring.
4. Add 5-40% (weight) of granules described in the present invention to melted chocolate, mix well. The food processers will choose the flavor of granules applied depends on consumer preferences, single flavor granule can be used or a combination of two types or more can be used. Pour the melted chocolate into mold while it is still hot. Cool down to room temperature, the chocolate thus made contain colorful granules inside, which is visually appealing. In addition, the granules inside also bring extra flavor to the chocolate besides its characteristic taste.
5. When prepare wheaten food, add 5-40% (weight) of granules described in the present invention to the dough, mix well. The food processers will choose the flavor of granules applied depends on consumer preferences, single flavor granule can be used or a combination of two types or more can be used. The dough can be made into steamed bread roll, bread, and noodle etc. The wheaten foods thus made contain colorful granules inside, which is visually appealing. In addition, the granules inside also bring extra flavor to the foods.
6. Add 1-10% (weight) of granules described in the present invention to snacks such as chips, tofu skins, and biscuits etc. mix well. The food processers will choose the flavor of granules applied depends on consumer preferences, single flavor granule can be used or a combination of two types or more can be used. The snacks thus made are visually appealing and the granules on top will bring extra flavor to the foods.

What claimed is:

1. Edible granules have varied flavors, the granules comprise: carbohydrates, water, emulsifiers, salt, sweeteners, flavor enhancers, acidity modifiers, food flavors, food colors and antioxidants. The amounts of them are: carbohydrates 70-80%, water 10-20%, emulsifiers 0-10%, salt 0-10%, sweeteners 0-10%, flavor enhancers 0-2%, acidity modifiers 0-2%, food flavors 0.01-1%, food colors 0-0.5% and antioxidants 0.01-0.04%.

2. Edible granules have varied flavors according to claim 1. Specifically, the carbohydrates are sugar, glucose, starch, fructose, trehalose, food fiber, and dextrin etc. They can be used individually or used as a combination of two or more of them.

3. Edible granules have varied flavors according to claim 1. Specifically, the emulsifiers described are Arab gum, guar gum, pectins, propylene glycol esters of fatty acids, mono- and diglycerides of fatty acids, propylene glycol alginate, succinylated monoglycerides, polyglycerol polyricinoleate, polyglycerol esters of fatty acids, polyoxyethylenexylitanmonostearate (Tween 20, 40, 60, 80), carrageenan, soybean polysaccharide, citric and fatty acid esters of glycerol, glycerol ester of hydrogenated rosin, sorbitan fatty acid esters (Span 20, 40, 60, 65, 80), diacetyl tartaric acid ester of mono glycerides, octyl and decylglycerate, sodium starch octenyl succinate, potassium stearate, and sucrose esters of fatty acid etc. They can be used individually or used as a combination of two or more of them.

4. Edible granules have varied flavors according to claim 1. Specifically, the flavor enhancers described are alanine, glycine, disodium succinate, paprika oleoresin, monosodium glutamate, disodium inosine 5′-monophospate, and disodium guanosine 5′-monophosphate etc. They can be used individually or used as a combination of two or more of them.

5. Edible granules have varied flavors according to claim 1. Specifically, the sweeteners are neotame, glycyrrhizinate salts, mannitol, cyclamate salts, maltitol, lactitol, sucralose, sorbitol, thaumatin, sodium saccharin, alitame, aspartame, steviol glycosides, acesulfame potassium, isomaltulose, and mogroside V etc. They can be used individually or used as a combination of two or more of them.

6. Edible granules have varied flavors according to claim 1. Specifically, the acidity modifiers are fumaric acid (and its salt), adipic acid, tartaric acid, phosphoric acid (and its salts), calcium sulfate, citric acid (and its salt), metatartaric acid, potassium hydroxide, calcium hydroxide, lactic acid, potassium carbonate, sodium carbonate, and hydrochloric acid etc. They can be used individually or used as a combination of two or more of them.

7. Edible granules have varied flavors according to claim 1. Specifically, the food flavors described herein include both natural flavors such as essential oils and synthetic flavors. Generally flavors can be categorized according to their characteristic tastes, such as fruit flavors, flower flavors, meat flavors, seafood flavors, green flavors, cooling flavors, wood flavors, seasoning flavors, liquor flavors, dairy flavors, nut flavors, preserved fruit flavors. They can be used individually or used as a combination of two or more of them.

8. Edible granules have varied flavors according to claim 1. Specifically, the food colors are erythrosine, indigotine, titanium dioxide, lycopene, orange yellow, riboflavin, black currant red, carthamins yellow, monascus yellow pigment, monascus red, beta carotene, turmeric, curcumin, caramel color, quinolone yellow, paprika red, brilliant blue, tartrazine, sunset yellow, amaranth, carmine cochineal, copper chlorophyll, lutein, allura red, corn yellow, gardenia blue, gardenia yellow, and carbon black etc. They can be used individually or used as a combination of two or more of them.

9. Edible granules have varied flavors according to claim 1. Specifically, the antioxidants are tea polyphenol, tea polyphenol palmitate, butylated hydroxyanisole, butylated hydroxytoluene, sulfur dioxide, potassium metabisulphite, sodium metabisulphite, glycyrrhiza extract, 4-hexylresorcinol, ascorbic acid (and its salts), ascorbyl palmitate, phospholipid, dilaurylthiodipropionate, propyl gallate, rosemary extract, sorbic acid, tertiary butylhydroquinone, vitamin E, disodium ethylene-diamine-tetra-acetate, isoascorbic acid, phytic acid, and bamboo extract etc. They can be used individually or used as a combination of two or more of them.

10. Edible granules have varied flavors according to claim 1. Specifically, the edible granules described herein are prepared as follows:
Step 1: weigh carbohydrates, salt, sweeteners, and acidity modifiers according to the predetermined ratio; mix them well and grind into powders.
Step 2: weigh water, emulsifiers, food flavors, and food colors according to the predetermined ratio; mix them well to make a homogeneous solution.
Step 3: put the powders on the spouted fluidized bed, keep the temperature of bed between 60-90° C.; spray the solution onto the bed, while the temperature of spray nozzle is kept at 60-100° C. The granules form gradually, and they are ball-shaped with diameters between 0.5-10 mm.
